(19) United States
(12) Patent Application Publication
(10) Pub. No.: US 2009/0151577 A1
(43) Pub. Date: Jun. 18, 2009

(54) DEVICE FOR DRY-DECORATION

(75) Inventor: Umberto Giovanardi, Castellarano (IT)

Correspondence Address: BROWDY AND NEIMARK, P.L.L.C.;624 NINTH STREET, NW, SUITE 300, WASHINGTON, DC, 20001-5303, US

(73) Assignee: RP S.r.l, Roteglia (IT)

(21) Appl. No.: 12/303,949

(22) PCT Filed: Jun. 4, 2007
(86) PCT No.: PCT/IB2007/001464

§ 371 Date: Dec. 8, 2008

(30) Foreign Application Priority Data
Jun. 8, 2006 (IT) MO2006A000180
Apr. 4, 2007 (IT) MO2007A00121

(51) Int. Cl. B41F 17/00

(52) U.S. Cl. 101/44

(57) ABSTRACT

A device for dry-decorating comprising a mobile plane (2), predisposed for transporting ceramic bases (40) along a longitudinal direction (x); a silk screen (3), slidable in a transversal or longitudinal direction (y or x) along a tortuous trajectory in which at least an active tract (3a) of the screen (3) is arranged in a parallel position to the mobile plane (2), the silk screen (3) and the mobile plane (2) being perpendicular to a vertical plane; a hopper (6), predisposed to deposit powder material on the active plane (3a), which hopper (6) is slidable contactingly with the active tract (3a) of the silk screen (3) in a longitudinal or transversal direction (x or y).

The invention relates to a device for dry-decorating ceramic bases or bases made of other materials.

In particular, in the ceramic field dry decoration consists substantially in depositing a decorative motif in powder form onto a base constituted by one or more layers of powders to be pressed, or on layers of already-pressed powders forming a support. Following the dry-decoration, the base is sent on to final pressing, if necessary, or to a kiln for firing.

Devices are known for dry decorating which essentially comprise a mobile plane, predisposed for transporting the bases along a longitudinal direction, and a mobile silk screen positioned above the mobile plane. The silk screen, as is known, is substantially constituted by a surface affording perforated areas through which a powder substance can pass through the screen, and non-perforated zones, which are impermeable to passage of the powder substance. The perforated zones reproduce the decoration which is to be transferred to the bases. A hopper is located above the silk screen, which hopper has a discharge opening and one or more scraping elements, for example a doctor, arranged parallel to an edge of the lower discharge opening. The hopper, previously filled with a powder substance, typically a glaze, deposits a uniform layer of powder onto the silk screen.

In more detail, in known-type devices:
a) the silk screen is mobile and the discharge hopper is fixed and arranged transversally with respect to the longitudinal transport direction of the bases (rotary silk-screening machines);
b) the screen is fixed and the hopper is mobile, arranged parallel with respect to the longitudinal transport direction of the bases (flat silk-screening machines).

Analysing the case of devices of type a) above: the screen performs a sliding motion with respect to the hopper, the scraper element is arranged at the side of the discharge opening, downstream of the opening with respect to the relative sliding motion between the hopper and the screen.

The transversal extension of the hopper, and in particular the powder discharge opening, defines the maximum width of the decoration possible with the device, i.e. the maximum area that can be decorated in a transversal direction with respect to the advancement direction. No means are included for closing the hopper discharge opening.

The bases to be decorated are positioned on the mobile plane in succession, and are reciprocally distanced by predetermined separation steps; they are transported below the hopper discharge opening in order for each to receive its decoration. When the separated parts, i.e. the parts with no base occupying them, pass below the screen, the hopper powder discharge must be halted. This effect is determined by providing non-perforated zones of the screen, which extend transversally over the whole development of the discharge opening, and which are placed before the discharge opening when the powder discharge onto the moving plane is to be prevented. The motion of the silk screen must therefore be rigidly synchronised with the transport motion of the bases, so that the perforated zones of the screen and the bases to be decorated transit contemporaneously below the discharge opening. The perforated zones can reproduce the same decoration, or different decorations, such that the bases transiting below the hopper discharge opening can receive different decorations. As is easily understood, the rigid synchronisation which is necessary between the base transport motion and the motion or position of the screen means that the decoration received by each base assumes, on the base itself, a very precise position which cannot be modified (surface-centred work mode). This constitutes a limitation to the device decorative possibilities.

In the case of devices of type b), the decorations are released onto the stationary bases after the mobile plane has positioned them below the active plane of the silk screen. The perforated zones always reproduce the same decoration. This constitutes a great limitation to the decorative possibilities of the device.

The above-cited decorative limitations of devices a) and b) become more evident still as the dimensions of the bases to be decorated grow. The aim of the present invention is to provide a device for dry-decorating ceramic bases which obviates the drawbacks in the known-type devices.

An advantage of the device of the invention is that it enables a continuous variation of the positions the decoration received by each base can assume.

A further advantage of the device of the invention is that it enables an increase in the maximum transversal or longitudinal extension which the device can decorate.

Further characteristics and advantages of the device will better emerge from the detailed description that follows, made with reference to the accompanying figures of the drawings, given purely by way of non-limiting example, in which:

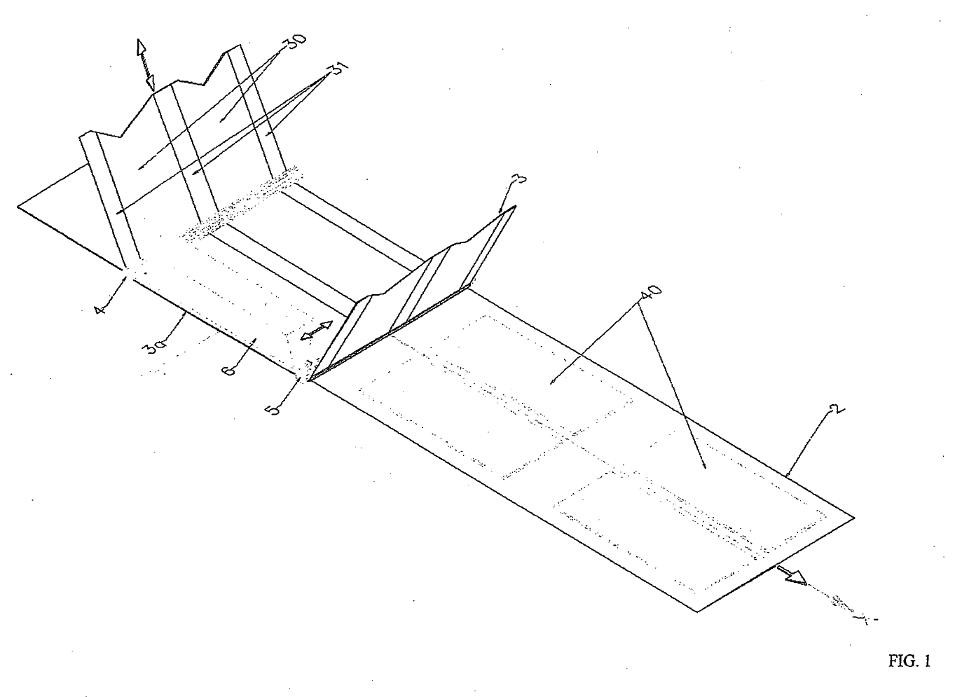

FIG. 1 is a schematic view of the functioning principle of the device of the present invention, in which the hopper 6 moves along a transversal direction y;

FIG. 2 is a second schematic view of the functioning principle of the device of the invention, in which the hopper 6 moves along a longitudinal direction x;

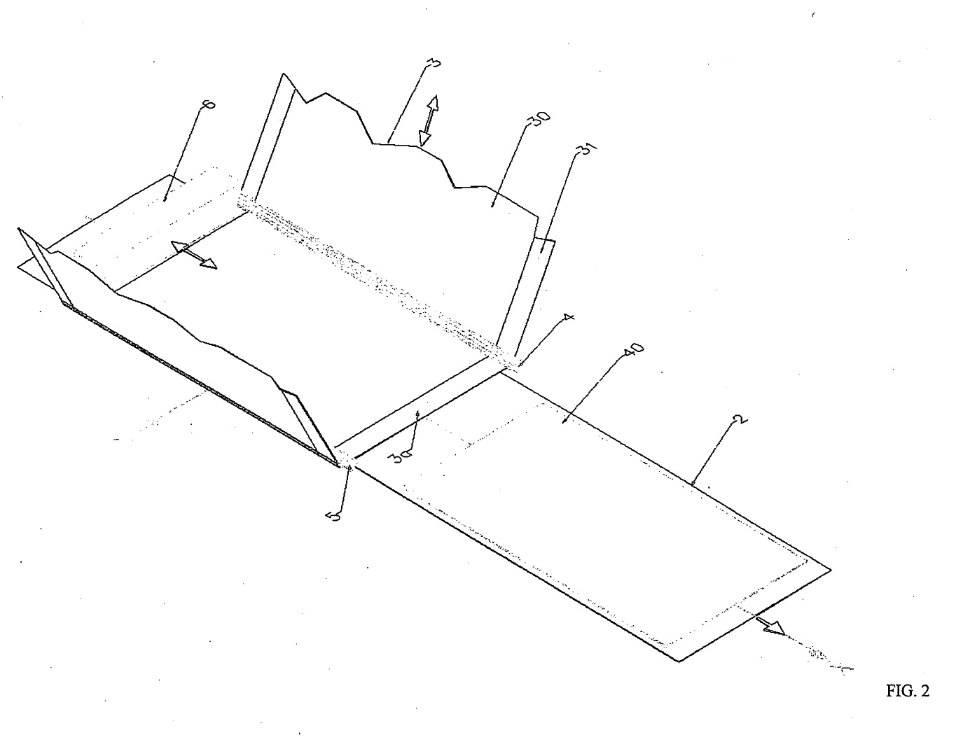

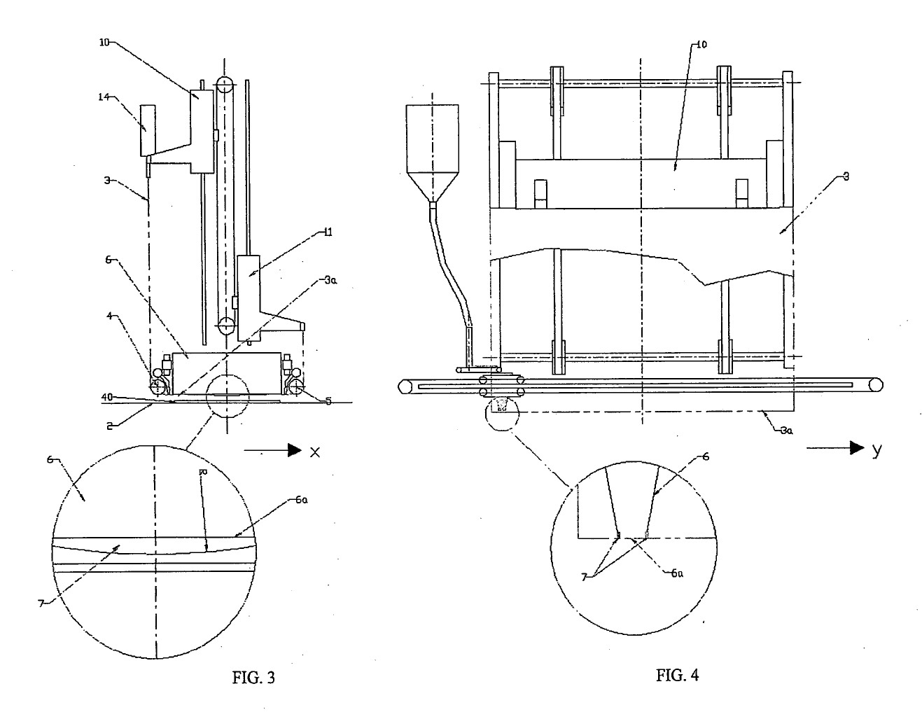

FIG. 3 is a view from y of a first embodiment of the device of FIG. 1 according to the present invention, with a detail in enlarged scale;

FIG. 4 is a view from x of a first embodiment of the device of FIG. 1 according to the present invention, with a detail in enlarged scale;

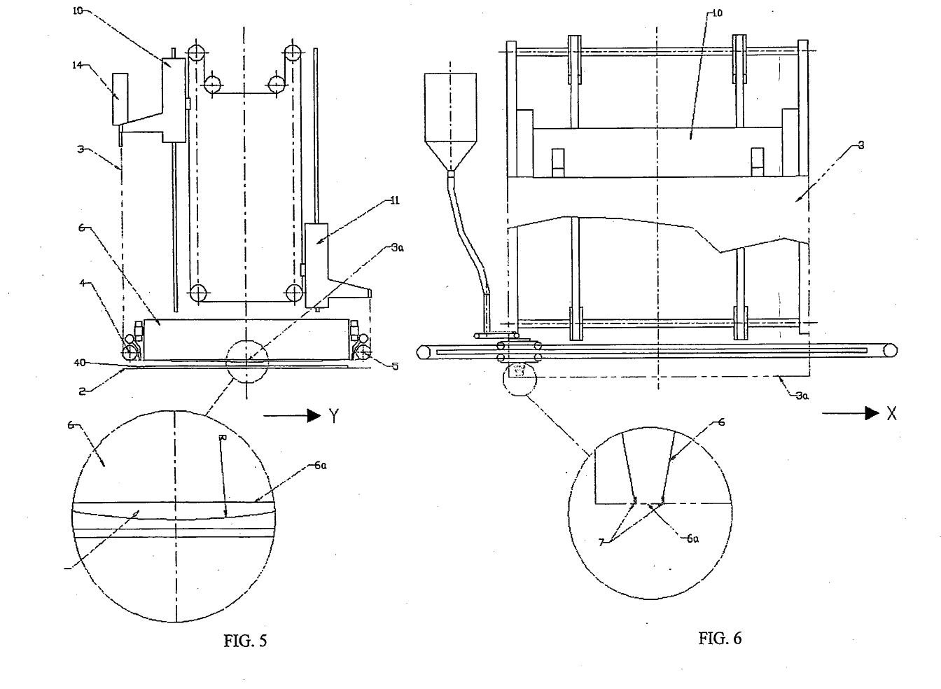

FIG. 5 is a view from x of a first embodiment of the device of FIG. 2 according to the present invention, with a detail in enlarged scale;

FIG. 6 is a view from y of a first embodiment of the device of FIG. 2 according to the present invention, with a detail in enlarged scale;

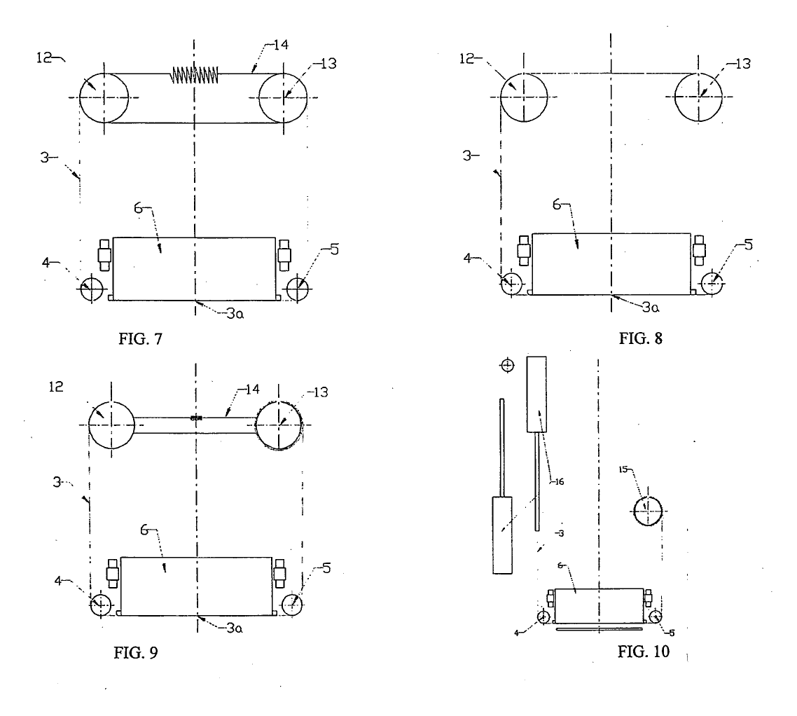

FIGS. 7, 8, 9 and 10 are views, along the sliding direction of the hopper 6, of some possible alternative solutions of the device according to the present invention.

With reference to the figures of the drawings, the device comprises a mobile plane 2, predisposed to transport ceramic bases 40 along a longitudinal direction x. The mobile plane 2 can be constituted for example by a roller plane or by a conveyor belt.

A silk screen 3, which is ribbon-shaped, is mobile above the mobile plane 2, along a tortuous trajectory in which at least one active tract 3a of the screen 3 is arranged in a parallel position to the mobile plane 2.

The tortuous trajectory of the screen 3 is defined by a series of rollers (which will be described in detail herein below) about which the screen is bent. The active tract 3a of the silk screen 3 is delimited by two guide rollers 4 and 5 which are horizontal and around which the silk screen 3 runs. The two guide rollers 4 and 5 substantially define a horizontal plane of the silk screen 3 on which the active plane 3a lies.

The silk screen 3 and the mobile plane 2 are preferably substantially perpendicular to a vertical plane, such that the hopper 6, which runs along the active tract 3a of the screen 3, and the mobile plane 2 are mobile along perpendicular directions as in FIG. 1, or parallel as in FIG. 2. The silk screen 3 is provided with at least a perforated portion 30, transversal with respect to the sliding direction of the hopper 6 across which the powder material can pass through the screen, and at least a non-perforated portion 31, also transversal with respect to the sliding direction of the hopper 6, which does not allow passage of the powder material. The portions 30 and 31 are substantially continuous strips of the silk screen 3, which at least on the active tract 3a of the screen 3 are arranged perpendicular to the transversal direction y in the embodiment of FIG. 1 and parallel to y in the embodiment of FIG. 2. Thanks to the arrangement of the perforations thereof, the perforated portion 30 reproduces a continuous decoration with absolutely no interruptions along the sliding direction of the silk screen 3 which, by defined portions, can be applied on the bases 40 positioned on the mobile transport plane 2. The presence of a plurality of continuous portions 30 and 31 enables simultaneous decoration of a plurality of bases with only one run of the hopper 6 above the active tract 3a.

As shown in FIG. 1, several perforated continuous portions 30, alternated with non-perforated continuous portions 31, can be located on the screen 3, in a position in which they overlie the bases 40 when the bases 40 are below the active tract 3a of the silk screen 3.

A hopper 6, predisposed to deposit powder material above the active tract 3a, is slidable contactingly on the active tract 3a in a longitudinal direction x or in a transversal direction y. A motor is provided to power the sliding motion of the hopper 6.

As is visible in the details of FIGS. 3, 4, 5 and 6, the hopper 6 substantially slides between the two guide rollers 4 and 5. Advantageously (see FIGS. 4 and 6) the hopper 6 is inferiorly provided with two parallel scraper elements 7, predisposed to slide contactingly on the active tract 3a of the silk screen 3 and to push the powder material deposited on the active tract 3a through the perforations of the screen 3. The scraper elements 7 are arranged transversally to the sliding direction of the hopper 6 and delimit a discharge opening 6a of the hopper 6. They also exhibit a concave transversal development, with a portion of apex located at an intermediate longitudinal section of the active tract 3a of the silk screen 3 (see details of FIGS. 3 and 5). The concavity of the scraper elements 7 enables a uniform pressure to be exerted on the active tract 3a of the silk screen 3.

The functioning of the device is as follows. The bases 40 are positioned below the active tract 3a of the silk screen 3, on the mobile plane 2. When the bases 40 are in position, the hopper performs one or more runs starting from an initial waiting position, situated in proximity of a lateral portion of the active tract 3a, towards one or more endrun positions of its run, whence it performs one or more return runs towards its initial position. During these runs, a predetermined quantity of powder material, previously loaded into the hopper 6 by means of known type (schematically illustrated in FIGS. 4 and 6) is placed in contact with the active tract 3a internally of the discharge opening 6a. The scraper elements 7, which are at the sides of the discharge opening 6a, push the powder material onto the surface of the active tract 3a. At the continuous perforated portion or portions 30, the powder material crosses the active tract 3a and deposits, substantially by force of gravity, on the underlying base or bases 40 to be decorated. The continuous portion or portions 31 do not allow passage of powder, thus substantially functioning as closures against the hopper discharge opening 6a. For this purpose, as shown in FIG. 2, a continuous non-perforated portion 31 is arranged at the hopper 6 start position, i.e. at the first lateral portion of the active tract 3a. Further non-perforated continuous portions 31 can be positioned at the separation spaces between the bases 40.

The special conformation of the silk screen 3, provided with the continuous portions 30 and 31 and the arrangement of the silk screen 3 and the hopper 6 with respect to the mobile plane 2, offers important advantages. The continuous perforated portions 30, which can be extended even over the whole length of the screen 3, without any interruption, enable continuous variation, along the sliding direction of the silk screen 3 of the position of the decoration on the bases 40. As previously mentioned, the continuous perforated portions 30 reproduce, through the arrangement of the perforations thereof, a continuous decoration which, for defined portions, can be applied on the bases 40 positioned on the mobile plane 2. The defined portions of continuous decoration, which time by time can be applied on the bases 40, are defined by the dimension which is transversal to the sliding direction of the discharge opening 6a of the hopper 6. By running the silk screen 3 along the tortuous trajectory, the continuous decoration portion which time-by-time is at the active tract 3a can be continuously varied.

The decorative possibilities do not depend only on the dimensions of the silk screen along the sliding direction of the hopper 6, but also on the translation run of the screen 3 along the tortuous trajectory, much greater than the single active tract 3a. By acting on the translation speed of the hopper 6 on the active tract 3a, different quantities of powder material can be applied on the bases even when applying the same decorations.

All of the foregoing enables use of large-area silk screens having great decorative versatility.

The decorable length long the hopper 6 sliding direction can be varied very simply by changing the run length of the hopper 6 itself. In particular, the decorable extension can be reduced from the maximum extension in order to adapt the device to the decoration of smaller-length bases, or a smaller number of bases aligned along x or y.

A motor is predisposed to actuate the sliding motion of the silk screen 3 along the tortuous trajectory.

In a first embodiment, illustrated in FIGS. 3, 4, 5 and 6, the motor activates the mobile elements 10 and 11 associated to opposite ends of the silk screen 3, which mobile elements 10 and 11 are slidable along respective sliding directions in order to draw the silk screen 3 in opposite directions. The sliding directions of the two mobile elements are preferably vertical. Means for tensioning 14 can be interposed between the screen and one or both the mobile elements 10 and 11 in order to keep the tension applied on the screen 3 constant. The means for tensioning 14 are constituted, for example, by pneumatic cylinders or elastic elements.

In a second embodiment, illustrated in FIG. 7, the motor comprises a pair of motorised rollers 12 and 13 associated to opposite ends of the silk screen 3 which are rotated in order to wind or unwind the screen 3 in order to draw the screen 3 in opposite directions. In this case too the tensioning means can be interposed between the screen 3 and both the motorised rollers 12 and 13, or, if of the torsioning type, can act directly on the motorised rollers in order to keep the tension the screen is subjected to constant. In a third embodiment (FIG. 8) a single roller can be powered (for example roller 13) and the rotation motion can be transmitted to the other roller direction by the tensioned screen by means of other tensioning means such as, for example, the other roller 12, which is in this case idle.

Alternatively, as shown in FIG. 9, the motion can be transmitted by the motorised roller 13 to the other idle roller 12 by means of a belt. The belt can be provided with a certain degree of elasticity in order that it can also constitute the tensioning means 14.

In a fourth embodiment, illustrated in FIG. 10, the motor comprises a motorised roller 15 connected to an end of the silk screen 3, predisposed to wind and unwind at least a tract of the silk screen, and a pulling element 16, connected to the other end of the silk screen and predisposed to exert a traction which opposes the winding action of the motorised roller 15.

1-13. (canceled)

14. A device for dry-decorating characterised in that it comprises a mobile plane (2), predisposed for transporting ceramic bases (40) along a longitudinal direction (x); a silk screen (3), slidable in a longitudinal direction (x) above the mobile plane (2) along a tortuous trajectory in which at least an active tract (3a) of the screen (3) is arranged in a parallel position to the mobile plane (2), the silk screen (3) and the mobile plane (2) being perpendicular to a vertical plane; a hopper (6), predisposed to deposit powder material above the active plane (3a), which hopper (6) is slidable contactingly with the active tract (3a) of the silk screen (3) in a longitudinal or transversal direction (x or y).

15. The device of claim 14, wherein the silk screen (3) is provided with at least a perforated longitudinal or transversal portion (30), through which the powder material can cross the screen (3), and at least a non-perforated longitudinal or transversal portion (31), which does not allow passage of the powder material.

16. The device of claim 15, wherein the at least a perforated portion (30) and the at least a non-perforated portion (31) exhibit a longitudinal or transversal extension which is greater than a longitudinal or transversal extension of the bases (40) and are without any transversal or transversal interruption along the whole extension thereof.

17. The device of claim 14, wherein the hopper (6) is inferiorly provided with two parallel scraper elements (7), predisposed to slide contactingly on the active tract (3a) of the silk screen (3) and to contain and push the powder material along the active tract (3a).

18. The device of claim 17, wherein the scraper elements (7) are substantially arranged parallel to the longitudinal or transversal direction (x) and exhibit a concave transversal or longitudinal development.

19. The device of claim 14, in which the active tract (3a) of the silk screen (3) is delimited by two horizontal guide rollers (4, 5), with which the silk screen (3) contactingly slides.

20. The device of claim 14, comprising motor means predisposed to actuate the sliding motion of the hopper (6).

21. The device of claim 14, comprising motor means predisposed to actuate the sliding motion of the silk screen (3) along the tortuous trajectory.

22. The device of claim 21, wherein the motor means comprise two mobile elements (10, 11) associated to opposite ends of the silk screen (3), which two mobile elements (10, 11) run in respective running directions in order to draw the silk screen (3) in opposite directions.

23. The device of claim 21, wherein the motor means comprise a pair of motorised rollers (12, 13) associated to opposite ends of the silk screen (3) and rotatable in order to wind and unwind the silk screen (3) such that the silk screen (3) is drawn to run in opposite directions.

24. The device of claim 23, wherein the silk screen (3) is ring-wound, only one roller of the pair of rollers (12, 13) being motorised.

25. The device of claim 21, wherein the motor means comprise: a motorised roller (15), connected to an end of the silk screen (3), predisposed to wind and unwind at least a tract of the silk screen (3); a pulling element (16), connected to the other end of the silk screen (3) and predisposed to exert a traction action on the silk screen (3).

26. The device of claim 21, comprising means for tensioning (14) predisposed to maintain constant the tension the silk screen (3) is subjected to.
